(19) United States
(12) Patent Application Publication
(10) Pub. No.: US 2008/0107405 A1
(43) Pub. Date: May 8, 2008

(54) Method for playing audio-video file and playing system using the same

(75) Inventors: Shu-Yi Chen, Taipei City (TW); Chang-Hung Lee, Yunlin County (TW)

Correspondence Address: RABIN & Berdo, PC, 1101 14TH STREET, NW, SUITE 500, WASHINGTON, DC, 20005, US

(73) Assignee: BenQ Corporation, Taoyuan Shien (TW)

(21) Appl. No.: 11/819,550

(22) Filed: Jun. 28, 2007

(30) Foreign Application Priority Data
Nov. 8, 2006 (TW) 95141415

(51) Int. Cl. H04N 7/26

(52) U.S. Cl. 386/124; 386/E05.001

(57) ABSTRACT

A method for playing an audio-video (AV) file is provided. The first AV file is played in a first or a second player. The first and the second players are coupled to one first digital media server. First, the first digital media server outputs a first AV file to the first player for playing the same. Next, the first player outputs a first pausing signal corresponding to the first AV file to the first digital media server. Then, the first digital media server pauses the first AV file and generates a first pausing data recording a first pausing time. Next, the second player outputs a pause-canceling signal to the first digital media server. When the pause-canceling signal corresponds to the first AV file, the first digital media server starts outputting the first AV file to the second player from the first pausing time.

This application claims the benefit of Taiwan application Serial No. 95141415, filed Nov. 8, 2006, the subject matter of which is incorporated herein by reference.

### BACKGROUND OF THE INVENTION

1. Field of the Invention

The invention relates in general to a method for playing an audio-video (AV) file and a player using the same, and more particularly to a method for playing the same audio-video (AV) file in different player from the original player where the AV file is paused.

2. Description of the Related Art

Along with the popularity of consumer electronic products, the functions of home appliances are not limited to receiving programs from wireless or cable channels or playing records in storage media such as optical discs and AV files. The current home appliances must possess the functions of directly playing a digital AV file, heralding an age of digital home appliances.

Taking TV, the most common home appliance in a family, for example. Currently a digital AV file can be played in a TV (flat panel display) which is connected to a server via the local area network(LAN). However, this method does not make much difference with a conventional TV. To further realize the convenience of digital home appliances, the digital home appliances must break through the restriction of time and space and provide instant accessibility.

For example, when a user is viewing a digital movie played in a TV at the lounge during the night time, the user may choose to view the remaining part of the movie at his bedroom lest other family members might be interfered with. When the user returns to his bedroom and turns the TV on, the user has to connect the TV to the server to search the digital file of the movie first. Then, the user has to play the movie and look for where the movie paused. This method does not make much difference with the conventional way of viewing a digital AV file in a computer, and does not bring further convenience to the user.

### SUMMARY OF THE INVENTION

The invention is directed to a method for playing an audio-video (AV) file and a player using the same. The invention enables an AV file to pause and resumes playing the same AV file with another player different from original player where the AV file was paused, hence achieving seamless playback function.

According to a first aspect of the present invention, a method for playing an audio-video (AV) file is provided. A first AV file is played in a first player or a second player. The first player and the second player are coupled to at least one first digital media server. The method includes the following steps. First, the first digital media server outputs a first AV file to the first player for playing the same. Next, the first player outputs a first pausing signal corresponding to the first AV file to the first digital media server. Then, the first digital media server pauses the first AV file and generates a first pausing data recording a first pausing time at which the first AV file paused in the first player. Next, the second player outputs a pause-canceling signal to the first digital media server. Then, if only the first AV file pauses, the pause-canceling signal is determined to be corresponding to the first AV file. When the pause-canceling signal corresponds to the first AV file, the first digital media server starts to output the first AV file to the second player from the first pausing time such that the second player continues to play the remaining part of the first AV file.

According to a second aspect of the present invention, a digital media playing system including a first player, a second player, and a digital media server is provided. The digital media server is coupled to the first player and the second player. The digital media server includes a control unit and a transmitting-receiving unit. The control unit is for controlling the output and the output-pause of a first AV file. The transmitting-receiving unit is coupled to the control unit and is controlled by the control unit to output the first AV file to be played in the first player or the second player. When the digital media server outputs the first AV file to the first player, if the first player outputs a first pausing signal corresponding to the first AV file to the transmitting-receiving unit of the digital media server, then the control unit controls the transmitting-receiving unit to pause the first AV file, and generate a first pausing data recording a first pausing time at which the first AV file paused in the first player. When the second player outputs a pause-canceling signal to the transmitting-receiving unit, if only the first AV file pauses, the control unit determines the pause-canceling signal to be corresponding to the first AV file. When the pause-canceling signal corresponds to the first AV file, the control unit of the digital media server controls the transmitting-receiving unit to output the first AV file to the second player from the first pausing time such that the second player continues to play the remaining part of the first AV file.

The invention will become apparent from the following detailed description of the preferred but non-limiting embodiments. The following description is made with reference to the accompanying drawings.

### BRIEF DESCRIPTION OF THE DRAWINGS

FIG. 1 is a block diagram showing the function of a digital media playing system according to the first embodiment of the invention;

FIG. 2 is a flowchart of an AV file playing method according to the first embodiment of the invention;

FIG. 3 is a block diagram showing the function of a digital media playing system according to the second embodiment of the invention;

FIGS. 4A-4B are flowcharts of an AV file playing method according to the second embodiment of the invention;

FIG. 5 is a illustration of a pausing file list according to the second embodiment of the invention;

FIG. 6 is a block diagram showing the function of a digital media playing system according to the third embodiment of the invention;

FIGS. 7A-7B are flowcharts of an AV file playing method according to the third embodiment of the invention; and

FIG. 8 is a illustration of a pausing file list according to the third embodiment of the invention.

### DETAILED DESCRIPTION OF THE INVENTION

### First Embodiment

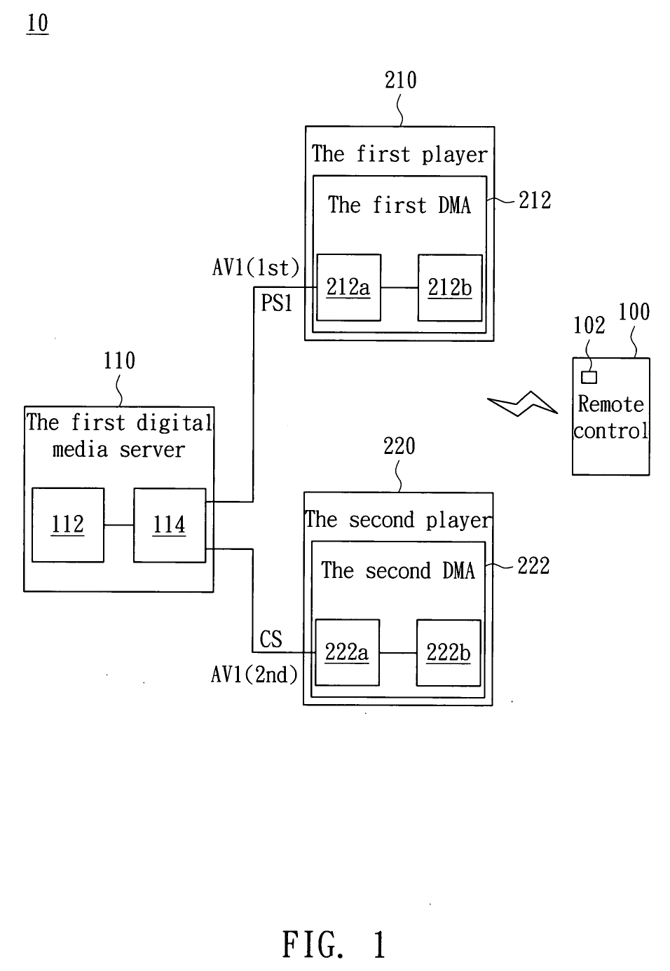

Referring to FIG. 1, a block diagram showing the function of a digital media playing system according to the first embodiment of the invention is shown. The digital media playing system 10 includes a first digital media server 110, a first player 210 and a second player 220. The first player 210 and the second player 220 are both coupled to the first digital media server 110. The first player 210 and the second player 220 are respectively exemplified by a TV and a projector. The first player 210 and the second player 220 respectively have a first digital media adapter (DMA) 212 and a second DMA 222. The first DMA 212 and the second DMA 222 can be external devices respectively coupled to the first player 210 and the second player 220, or directly built in the first player 210 and the second player 220, respectively.

The first DMA includes a transmitting-receiving unit 212a and a processing unit 212b. The second DMA 222 includes a transmitting-receiving unit 222a and a processing unit 222b. The transmitting-receiving units 212a and 222a are used for receiving a first AV file AV1 outputted from the first digital media server 110. The processing units 212b and 222b convert the first AV file AV1 into a data format that can be received directly, such that the first AV file AV1 can be played in the first player 210 or the second player 220. The first digital media server 110 includes a control unit 112 and a transmitting-receiving unit 114. The control unit 112 receives a pausing signal and a pause-canceling signal for controling the transmitting-receiving unit 114 to output or pause outputting the first AV file AV1. The transmitting-receiving unit 114 is coupled to the control unit 112 and is controlled by the control unit 112 for outputting the first AV file AV1 to be played in the first player 210 or the second player 220, and for receiving the pausing signal and the pause-canceling signal.

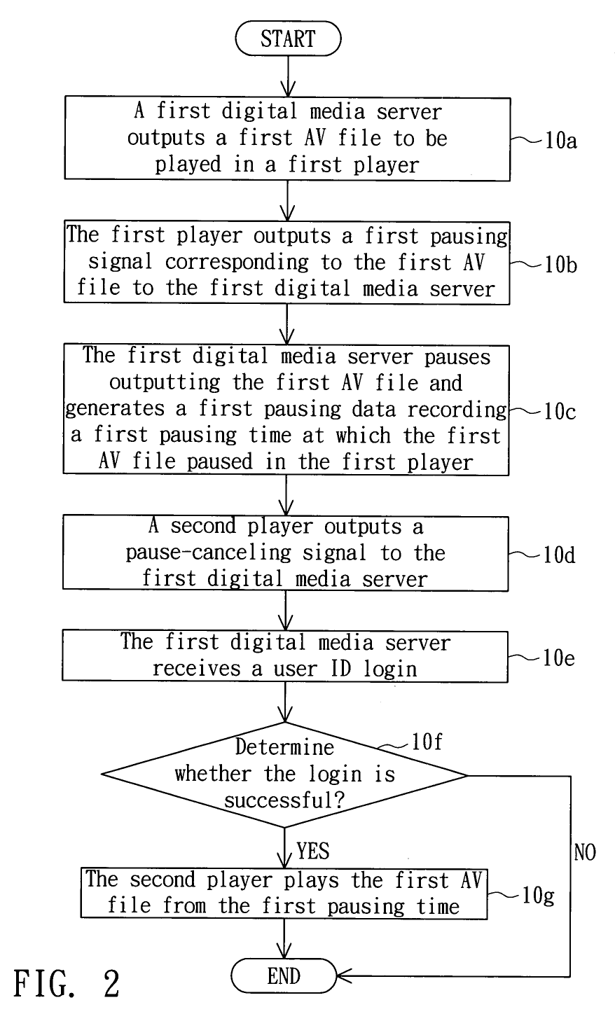

Referring to FIG. 2, a flowchart of an AV file playing method according to a first embodiment of the invention is shown. Also refer to the numeric designations of the elements of FIG. 1.

First, as indicated in step 10a, the transmitting-receiving unit 114 of the first digital media server 110 outputs the first AV file AV1 to be played in the first player 210.

Next, as indicated in step 10b, the transmitting-receiving unit 212a of the first player 210 outputs a first pausing signal PS1 corresponding to the first AV file AV1 to the transmitting-receiving unit 114 of the first digital media server 110.

Then, as indicated in step 10c, the control unit 112 of the first digital media server 110 controls the transmitting-receiving unit 114 to pause outputting the first AV file AV1 and to generate a first pausing data recording a first pausing time at which the first AV file AV1 paused in the first player 210.

Next, as indicated in step 10d, the transmitting-receiving unit 222a of the second player 220 outputs a pause-canceling signal CS to the transmitting-receiving unit 114 of the first digital media server 110. In the present embodiment of the invention, only the first AV file AV1 pauses, so the control unit 112 of the first digital media server 110 directly determines the pause-canceling signal CS to be corresponding to the first AV file AV1.

Then, as indicated in step 10e, the first digital media server 110 receives a user identity(ID) login via the transmitting-receiving unit 114.

Next, as indicated in step 10f, the control unit 112 of the first digital media server 110 determines whether the login is successful. If the login is successful, then as indicated in step 10g, the control unit 112 of the first digital media server 110 controls the transmitting-receiving unit 114 to start outputting the first AV file AV1 to the second player 220 from the first pausing time, and after the data of the first AV file AV1 is converted by the second DMA 222, the first AV file AV1 continues to be played in the second player 220 from the first pausing time. If the control unit 112 of the first digital media server 110 determines that the login fails, this process is terminated directly.

Furthermore, as indicated in FIG. 1, the digital media playing system 10 further includes a remote control 100. The remote control 100 controls the first player 210 or the second player 220 to output the first pausing signal PS1 or the pause-canceling signal CS. Let the present embodiment of the invention be taken for example. The remote control 100 has a function key 102. When the first player 210 is turned on, the first player 210 outputs the first pausing signal PS1 after the function key 102 is triggered. When the second player 220 is turned off, the second player 220 is turned on and outputs the pause-canceling signal CS after the function key 102 is triggered again.

### Second Embodiment

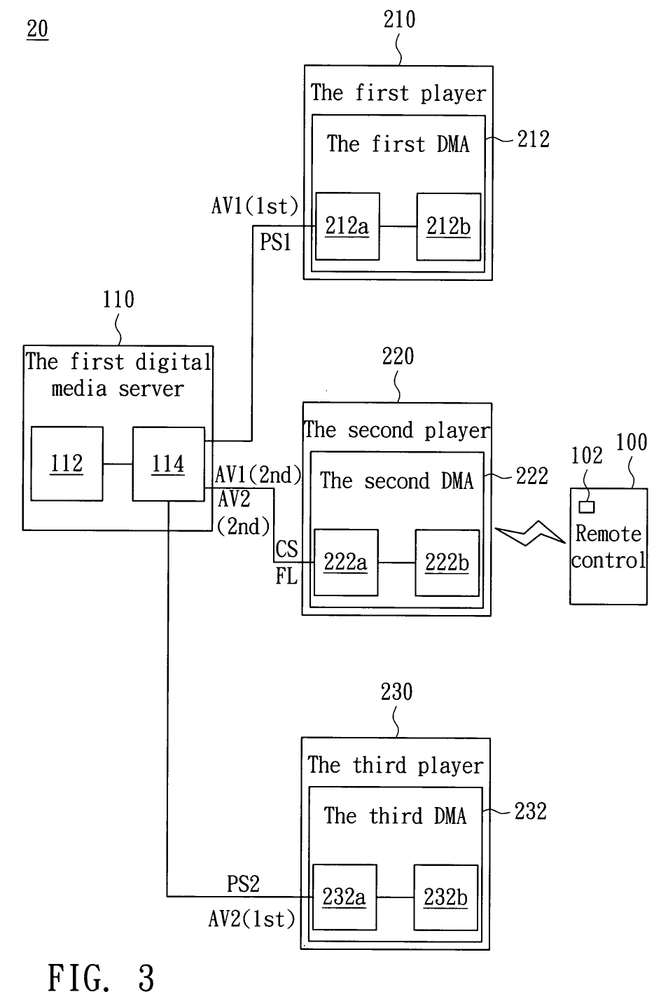

Referring to FIG. 3, a block diagram showing the function of a digital media playing system according to the second embodiment of the invention is shown. The digital media playing system 20 differs from the digital media playing system 10 of the first embodiment in that the first digital media server 110 is further coupled to a third player 230. This implies that in the present embodiment of the invention, the digital media server can be coupled to more players, such that the user can view an AV file at different venues seamlessly. The third player 230, the first player 210, and the second player 220 have the same function. Likewise, the third DMA 232 of the third player 230 has the same function as the first DMA 212 and the second DMA 222 do; the transmitting-receiving unit 232a and the processing unit 232b of the third DMA 232 have the same functions as the transmitting-receiving unit 212a and the processing unit 212b of the first DMA 212 as well as the transmitting-receiving unit 222a and the processing unit 222b of the second DMA 222 do. The third DMA 232 is used for receiving the first AV file AV1 or the second AV file AV2 outputted from the first digital media server 110 and for converting the data of the AV file into reveiceable format.

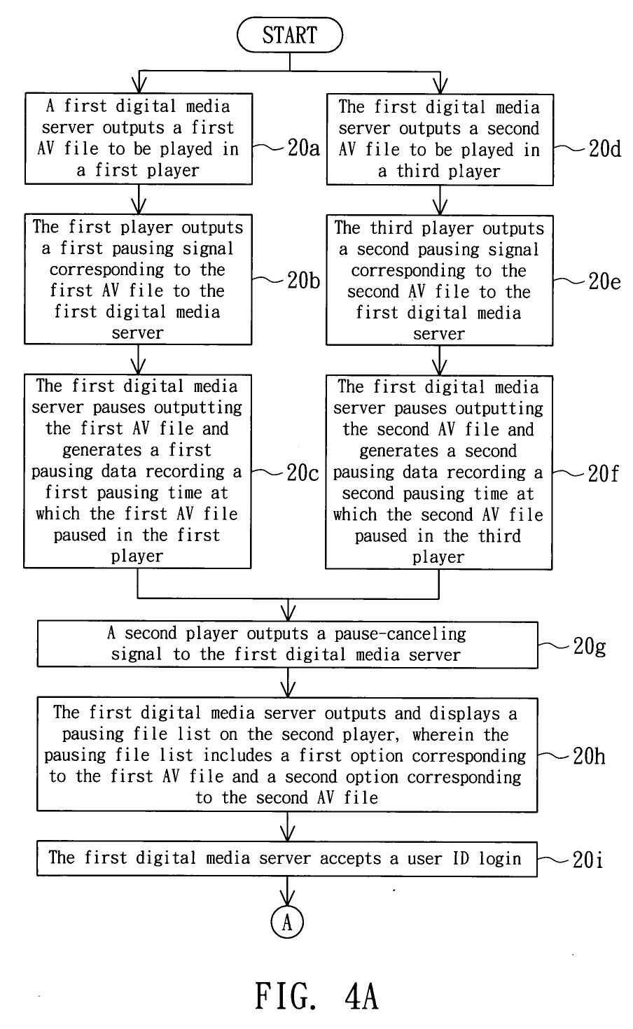

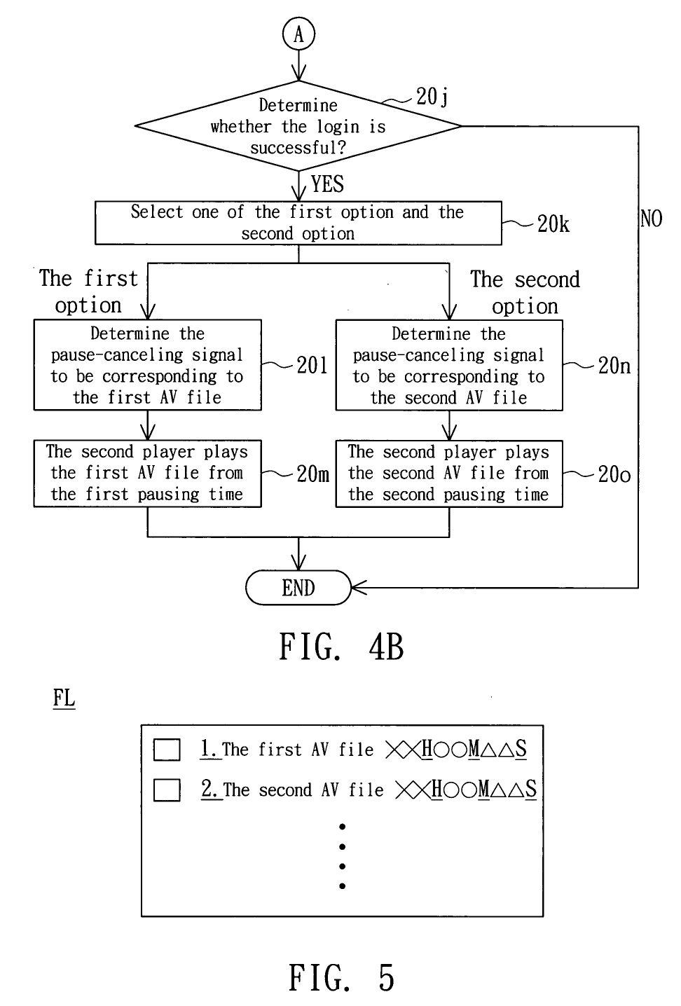

Referring to FIGS. 4A˜4B, flowcharts of an AV file playing method according to a second embodiment of the invention are shown. Also refer to the numeric designations of the elements of FIG. 3.

First, as indicated in step 20a and 20d, the first digital media server 110 outputs the first AV file AV1 and the second AV file AV2 to be played in the first player 210 and the third player 230, respectively.

Next, as indicated in step 20b and 20e, the transmitting-receiving unit 212a of the first player 210 and the transmitting-receiving unit 232a of the third player 230 respectively output the first pausing signal PS1 corresponding to the first AV file AV1 and the second pausing signal PS2 corresponding to the second AV file AV2 to the transmitting-receiving unit 114 of the first digital media server 110.

Then, as indicated in step 20c and 20f, the control unit 112 of the first digital media server 110 controls the transmitting-receiving unit 114 to pause outputting the first AV file AV1 and to generate a first pausing data recording a first pausing time at which the first AV file AV1 paused in the first player 210. The control unit 112 of the first digital media server 110 also controls the transmitting-receiving unit 114 to pause outputting the second AV file AV2 and generate a second pausing data recording a second pausing time at which the second AV file AV2 paused in the third player 230.

Next, as indicated in step 20g, when the first AV file AV1 or the second AV file AV2 is to be played in the second player 220, the transmitting-receiving unit 222a of the second player 220 outputs a pause-canceling signal CS to the transmitting-receiving unit 114 of the first digital media server 110.

Then, as indicated in step 20h, after the transmitting-receiving unit 114 of the first digital media server 110 receives the pausing signal CS, a pausing file list FL is outputted and displayed on the second player 220 under the control of the control unit 112. As indicated in FIG. 5, a illustration of a pausing file list according to the second embodiment of the invention is shown. The pausing file list FL includes a first choice corresponding to the first AV file AV1 and a second choice corresponding to the second AV file AV2. Next, as indicated in step 20i, the transmitting-receiving unit 114 of the first digital media server 110 accepts a user login.

Then, as indicated in step 20j, the control unit 112 of the first digital media server 110 determines whether the login is successful. If the login is determined to be successful, one of the first choice and the second choice is selected from the pausing file list as indicated in step 20k. If the control unit 112 of the first digital media server 110 determines that the login fails, the present method is terminated.

If the first option is selected, the control unit 112 of the first digital media server 110 determines the pause-canceling signal CS to be corresponding to the first AV file AV1 as indicated in step 201. Next, as indicated in step 20m, the control unit 112 of the first digital media server 110 controls the transmitting-receiving unit 114 to start outputting the first AV file AV1 to the transmitting-receiving unit 222a of the second player 220 from the first pausing time, such that the second player 220 plays the first AV file AV1 from the first pausing time.

If the second option is selected, the control unit 112 of the first digital media server 110 determines the pause-canceling signal CS to be corresponding to the second AV file AV2 as indicated in step 20n. Next, as indicated in step 20o, the control unit 112 of the first digital media server 110 controls the transmitting-receiving unit 114 to start outputting the second AV file AV2 to the transmitting-receiving unit 222a of the second player 220 from the second pausing time, such that the second player 220 plays the second AV file AV2 from the second pausing time.

Moreover, the first player 210 can play and pause the second AV file AV2, and generate a corresponding pausing file in the first digital media server 110. The pausing file records the first pausing time and the second pausing time. Or, the first AV file AV1 or the second AV file AV2 can respectively pause in the same player or different players for a number of times, and the corresponding pausing times can be recorded, respectively. Therefore, as indicated in FIG. 5, the pausing file list FL outputted from the first digital media server 110 preferably includes the name and the pausing time of the corresponding pausing file. Besides, the first digital media server 110 can further be coupled to more players.

### Third Embodiment

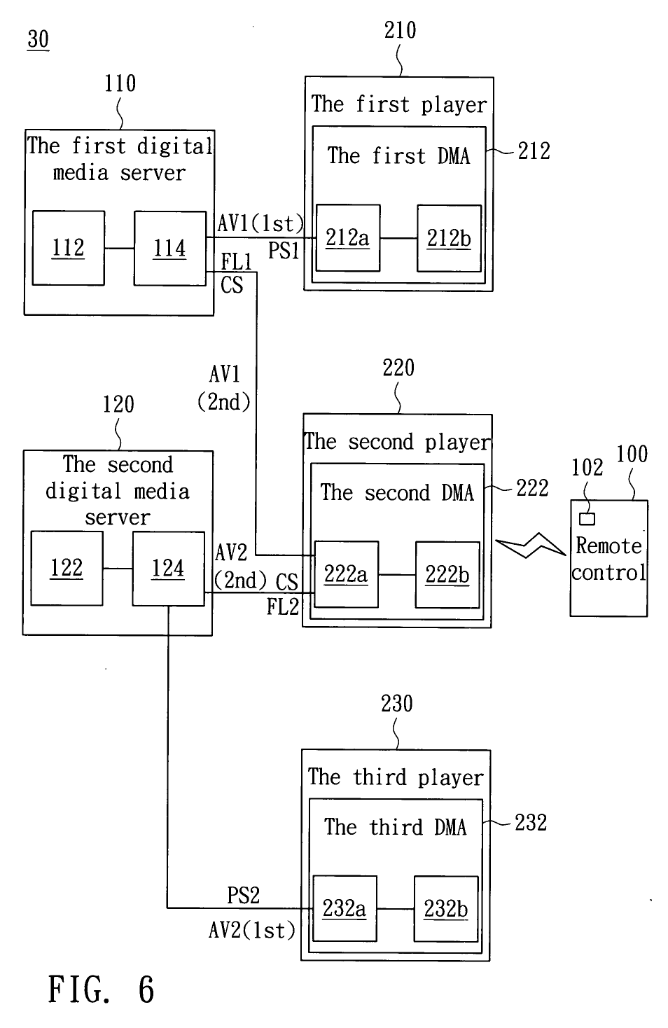

Referring to FIG. 6, a block diagram showing the function of a digital media playing system according to the third embodiment of the invention is shown. The digital media playing system 30 differs from digital media playing system 20 of the second embodiment in that the digital media playing system 30 further includes a second digital media server 120 coupled to the second player 220 and the third player 230, respectively. This implies that in the present embodiment, the invention can be applied to an audio-video system having multiple digital media servers, such that the user can view an AV file at more venues seamlessly. The second digital media server 120 has the same function as the first digital media server 110 does, and therefore the control unit 122 and the transmitting-receiving unit 124 both included in the second digital media server 120 also have the same functions as the control unit 112 and the transmitting-receiving unit 114 both included in the first digital media server 110 do, respectively. The transmitting-receiving unit 124 is for outputting the second AV file AV2 to be played in the third player 230 and for receiving a pausing signal and a pause-canceling signal.

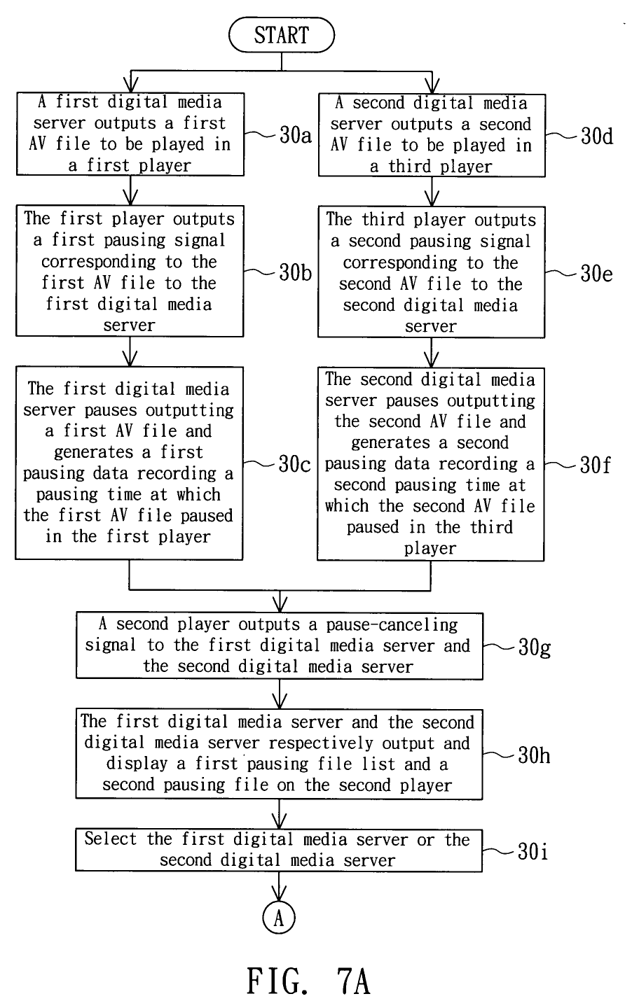

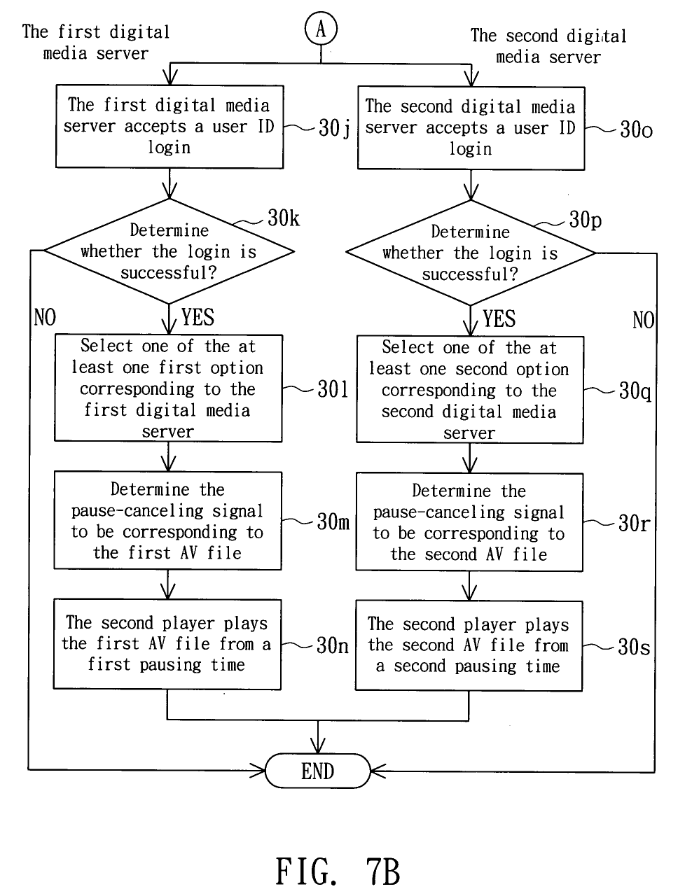

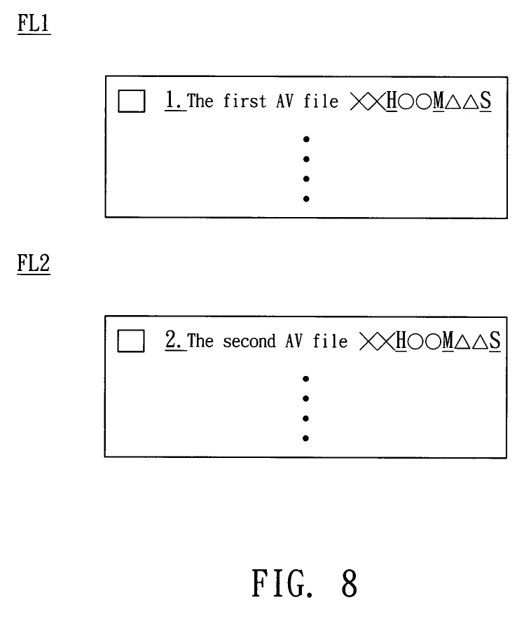

Referring to FIGS. 7A˜7B, flowcharts of an AV file playing method according to the third embodiment of the invention are shown. Also refer to the numeric designations of the elements of FIG. 6.

First, as indicated in step 30a and 30d, the first digital media server 110 and the second digital media server 120 respectively outputs a first AV file AV1 and a second AV file AV2. Then, after the first AV file AV1 and the second AV file AV2 are converted by the first DMA 212 and the third DMA 232, the first AV file AV1 and the second AV file AV2 are transmitted to be played in the first player 210 and the third player 230, respectively.

Next, as indicated in step 30b and 30e, the transmitting-receiving unit 212a of the first player 210 and the transmitting-receiving unit 232a of the third player 230 respectively outputs a first pausing signal PS1 corresponding to the first AV file AV1 and a second pausing signal PS2 corresponding to the second AV file AV2 to the transmitting-receiving unit 114 of the first digital media server 110 and the transmitting-receiving unit 124 of the second digital media server 120.

Then, as indicated in step 30c and 30f, the control unit 112 of the first digital media server 110 and the control unit 122 of the second digital media server 120 respectively control the transmitting-receiving unit 114 and the transmitting-receiving unit 124 to pause outputting the first AV file AV1 and the second AV file AV2 and generate a first pausing data and a second pausing data. The first pausing data records a first pausing time at which the first AV file AV1 paused in the first player 210. The second pausing data records a second pausing time at which the second AV file AV2 paused in the third player 230.

Next, as indicated in step 30g, the transmitting-receiving unit 222a of the second player 220 outputs the pause-canceling signal CS to the transmitting-receiving unit 114 of the first digital media server 110 and the transmitting-receiving unit 124 of the second digital media server 120 respectively.

Then, as indicated in step 30h, the control unit 112 of the first digital media server 110 controls the transmitting-receiving unit 114 to output and to display a first pausing file list FL1 on the second player 220; the control unit 122 of the second digital media server 120 controls the transmitting-receiving unit 124 to output and to display a second pausing file list FL2 on the second player 220. Referring to FIG. 8, a illustration of a pausing file list according to the third embodiment of the invention is shown. The first pausing file list FL1 includes at least one first option corresponding to the first AV file AV1. The second pausing file list FL2 includes at least one second option corresponding to the second AV file AV2.

Next, as indicated in step 30i, the first digital media server 110 or the second digital media server 120 is selected.

If the first digital media server 110 is selected, then the method proceeds to step 30j, and the transmitting-receiving unit 114 of the first digital media server 110 accepts a user ID login. Next, the method proceeds to step 30k, in which the control unit 112 determines whether the login is successful. If the login is successful, then the method proceeds to step 301, in which the user selects a first option corresponding to the selected first digital media server 110. Then, as indicated in step 30m, the control unit 112 determines the pause-canceling signal CS to be corresponding to the first AV file AV1. Next, as indicated in step 30n, the control unit 112 of the first digital media server 110 controls the transmitting-receiving unit 114 to start outputting the first AV file AV1 to the transmitting-receiving unit 222a of the second player 220 from the first pausing time, such that the second player 220 plays the first AV file AV1 from the first pausing time. If the login fails in step 30k, then the present method is terminated.

If the second digital media server 120 is selected, then the method proceeds to step 30o, in which the transmitting-receiving unit 124 of the second digital media server 120 accepts a user ID login. Next, the method proceeds to step 30p, in which the control unit 122 determines whether the login is successful. If the login is successful, then the method proceeds to step 30q, in which the user selects a second option corresponding to the selected second digital media server 120. Then, as indicated in step 30r, the control unit 122 determines the pause-canceling signal CS to be corresponding to the second AV file AV2. Next, as indicated in step 30s, the control unit 122 of the second digital media server 120 controls the transmitting-receiving unit 124 to start outputting the second AV file AV2 to the transmitting-receiving unit 222a of the second player 220 from the second pausing time, such that the second player 220 plays the second AV file AV2 from the second pausing time. If the login fails in the step 30p, then the present method is terminated.

Besides, as there is no data transmission between the first digital media server 110 and the third player 230 in the present embodiment of the invention, the first digital media server 110 and the third player 230 do not need to be connected. Likewise, the second digital media server 120 and the first player 210 do not need to be connected, either.

In the present embodiment of the invention, multiple digital media servers and players can be mutually coupled to create a digital audio-video network system.

According to the method for playing audio-video (AV) file and player using the same disclosed in the above embodiments of the invention, via the digital media playing system composed of multiple digital media servers and players, when one of the players pauses an AV file, the AV file can be played in another player seamlessly. Furthermore, the function key of the remote control enables the user to conveniently pause and resume the AV file. The invention transcends the restriction of time and space, and provides the user with a convenient digital media playing system. For example, when the user is viewing an AV file at the study room or the lounge, the user can continue to view the AV file at his bedroom until he falls asleep. Or, if the user has to leave when viewing an AV file, the user can resume the AV file from where the AV file paused. Or, if the AV file is long, the user can view the AV file segment by segment.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for playing an audio-video (AV) file, used for playing a first AV file in a first player or a second player coupled to a first digital media server, the method comprising the steps of:
a. outputting the first AV file to the first player by the first digital media server and playing the first AV file in the first player;
b. outputting a first pausing signal corresponding to the first AV file to the first digital mediaserver by the first player;
c. pausing the first AV file and generating a first pausing data by the first digital media server, wherein the first pausing data records a first pausing time at which the first AV file paused in the first player;
d. outputting a pause-canceling signal to the first digital media server by the second player; and
e. determining the pause-canceling signal to be corresponding to the first AV file if only the first AV file pauses, and outputting the first AV file to the second player by the first digital media server and playing the first AV file in the second player from the first pausing time when the pause-canceling signal corresponds to the first AV file.

2. The playing method according to claim 1, wherein between the step d and the step e, the method further comprises:
accepting a user identity(ID) login by the first digital media server, and performing the step e if the login is successful and terminating the method if the login fails.

3. The playing method according to claim 1, wherein the first player and the second player respectively have a first digital media adapter (DMA) unit and a second DMA both used for receiving the first AV file outputted from the first digital media server, and for converting data so as to play the first AV file.

4. The playing method according to claim 1, wherein the first or the second player is controlled by a remote control, which controls the first or the second player to output the first pausing signal or the pause-canceling signal.

5. The playing method according to claim 4, wherein the remote control has a function key, when the first player is turned on, the first player outputs the first pausing signal after the function key is triggered, and when the second player is turned off, the second player is turned on and outputs the pause-canceling signal after the function key is triggered.

6. The playing method according to claim 1, wherein the first digital media server is further coupled to a third player, and before the step d, the method further comprises:
f. outputting a second AV file to the third player by the first digital media server and playing the second AV file in the third player;
g. outputting a second pausing signal corresponding to the second AV file to the first digital media server by the third player; and
h. pausing the second AV file and generating a second pausing data by the first digital media server, wherein the second pausing data records a second pausing time at which the second AV file paused in the third player.

7. The playing method according to claim 6, wherein the third player has a third DMA used for receiving the first AV file or the second AV file outputted from the first digital media server and for converting data.

8. The playing method according to claim 6, wherein before the step d and the step e, the method further comprises:
i. outputting and displaying a pausing file list on the second player by the first digital media server, wherein the pausing file list comprises a first option corresponding to the first AV file and a second option corresponding to the second AV file;
j. selecting one of the first option and the second option; and
k. determining the pause-canceling signal of the step d to be corresponding to the first AV file if the first option is selected and determining the pause-canceling signal of the step d to be corresponding to the second AV file if the second option is selected.

9. The playing method according to claim 8, wherein the step e further comprises:
playing the second AV file in the second player from the second pausing time when the pause-canceling signal corresponds to the second AV file.

10. The playing method according to claim 8, wherein between the step i and the step j, the method further comprises:
accepting a user ID login by the first digital media server, then performing the step j if the login is successful and terminating the method if the login fails.

11. The playing method according to claim 1, the method further for playing a second AV file in a third player coupled to a second digital media server, wherein the second digital media server is coupled to the second player, and before the step d, the method further comprises:
f. outputting the second AV file to the third player by the second digital media server and playing the second AV file in the third player;
g. outputting a second pausing signal corresponding to the second AV file to the second digital media server by the third player; and
h. pausing the second AV file and generating a second pausing data by the second digital media server, wherein the second pausing data records a second pausing time at which the second AV file paused in the third player.

12. The playing method according to claim 11, wherein the step d further comprises:
outputting the pause-canceling signal to the second digital media server by the second player;
wherein, between the step d and the step e, the method further comprises:
i. outputting and displaying a first pausing file list on the second player by the first digital media server, and outputting and displaying a second pausing file list on the second player by the second digital media server, wherein the first pausing file list comprises at least one first option, one of the at least one first option corresponds to the first AV file, the second pausing file list comprises at least one second option, and one of the at least one second option corresponds to the second AV file;
j. selecting the first digital media server or the second digital media server; and
k. selecting one of the at least one first option or one of the at least one second option corresponding to the first digital media server or the second digital media server, whichever is selected, wherein the pause-canceling signal of the step d is determined to be corresponding to the first AV file if the first option corresponding to the first AV file is selected, and determining the pause-canceling signal of the step d to be corresponding to the second AV file if the second option corresponding to the second AV file is selected;
wherein, the step e further comprises:
playing the second AV file in the second player from the second pausing time when the pause-canceling signal corresponds to the second AV file.

13. The playing method according to claim 12, wherein between the step j and the step k, the method further comprises:
accepting a user ID login by the the first digital media server or the selected second digital media server, whichever is selected, and then performing the step k if the login is successful and terminating the method if the login fails.

14. A digital media playing system, comprising:
a first player;
a second player; and
a digital media server coupled to the first player and the second player, wherein the digital media server comprises:
a control unit used for controling the output and the output-pause of a first AV file; and
a transmitting-receiving unit coupled to the control unit and controlled by the control unit for outputting the first AV file to be played in the first player or the second player;
wherein, when the digital media server outputs the first AV file to the first player, if the first player outputs a first pausing signal corresponding to the first AV file to the transmitting-receiving unit of the digital media server, then the control unit controls the transmitting-receiving unit to pause the first AV file and to generate a first pausing data recording a first pausing time at which the first AV file paused in the first player; when the second player outputs a pause-canceling signal to the transmitting-receiving unit, if only the first AV file pauses, then the control unit determines the pause-canceling signal to be corresponding to the first AV file; when the pause-canceling signal corresponds to the first AV file, the control unit of the digital media server controls the transmitting-receiving unit to output the first AV file to the second player from the first pausing time such that the second player continues to play the first AV file.

15. The digital media playing system according to claim 14, wherein the first player and the second player respectively have a first DMA and a second DMA both used for receiving the first AV file outputted from the digital media server, converting data and playing the first AV file.

16. The digital media playing system according to claim 14, further comprises a remote control for controlling the first player or the second player to output the first pausing signal or the pause-canceling signal.

17. The digital media playing system according to claim 16, wherein the remote control has a function key, when the first player is turned on, the first player outputs the first pausing signal after the function key is triggered; when the second player is turned off, the second player is turned on and outputs the pause-canceling signal after the function key is triggered again.

18. The digital media playing system according to claim 14, further comprises a third player, coupled to the digital media server, for playing a second AV file outputted from the transmitting-receiving unit of the digital media server;
wherein, when the third player outputs a second pausing signal corresponding to the second AV file to the digital media server, the control unit of the digital media server controls the transmitting-receiving unit to pause outputting the second AV file and generate a second pausing data recording a second pausing time at which the second AV file paused in the third player.

19. The digital media playing system according to claim 18, the control unit of the digital media server further controlling the transmitting-receiving unit to output and display a pausing file list on the second player, the pausing file list at least comprising a first option corresponding to the first AV file and a second option corresponding to the second AV file;
wherein, when the first option is selected, the control unit of the digital media server determines the pause-canceling signal to be corresponding to the first AV file; when the second option is selected, the control unit of the digital media server determines the pause-canceling signal to be corresponding to the second AV file;
when the pause-canceling signal corresponds to the second AV file, the control unit of the digital media server controls the transmitting-receiving unit to start outputting the second AV file to the second player from the second pausing time.

20. The digital media playing system according to claim 19, wherein the transmitting-receiving unit of the digital media server further accepts a user ID login, if the control unit determines that the login is successful, then one of the first option and the second option is selected; if the login fails, the processing is terminated.

21. The digital media playing system server according to claim 18, wherein the third player has a third DMA used for receiving the first AV file outputted from the transmitting-receiving unit of the digital media server, converting data and playing the first AV file.

22. The digital media playing system according to claim 14, further comprising:
a third player having a third DMA; and
a second digital media server coupled to the second player and the third player, the second digital media server comprising:
a second control unit used for controling the output and the output-pause of a second AV file; and
a second transmitting-receiving unit coupled to the second control unit and controlled by the second control unit for outputting the second AV file to be played in the third player;
wherein, when the third player outputs a second pausing signal corresponding to the second AV file to the second transmitting-receiving unit of the second digital media server, the second control unit of the second digital media server controls the second transmitting-receiving unit to pause outputting the second AV file and generate a second pausing data recording a second pausing time at which the second AV file paused in the third player.

23. The digital media playing system according to claim 22, wherein, when the second player outputs the pause-canceling signal to the second transmitting-receiving unit of the second digital media server, the control unit of the digital media server further controls the transmitting-receiving unit to output and display a first pausing file list on the second player, the first pausing file list comprises at least one first option, one of the at least one first option corresponds to the first AV file, the second control unit of the second digital media server further controls the second transmitting-receiving unit to output and display a second pausing file list on the second player, the second pausing file list comprises at least one second option, one of the at least one second option corresponds to the second AV file;
when the first option corresponding to the first AV file is selected, the control unit of the digital media server determines the pause-canceling signal to be corresponding to the first AV file; when the second option corresponding to the second AV file is selected, the second control unit of the second digital media server determines the pause-canceling signal to be corresponding to the second AV file; when the pause-canceling signal corresponds to the second AV file, the second control unit of the second digital media server controls the second transmitting-receiving unit to start outputting the second AV file to the second player from the second pausing time.

24. The digital media playing system according to claim 23, wherein after the first digital media server or the second digital media server is selected, the first transmitting-receiving unit of the first digital media server or the second transmitting-receiving unit of the second digital media server, whichever is selected, accepts a user ID login, if the control unit or the second control unit determines that the login is successful, then one of the at least one first option or one of the at least one second option corresponding to the selected digital media server is selected; if the login fails, the processing is terminated.
